(19) United States
(12) Patent Application Publication
(10) Pub. No.: US 2003/0231829 A1
(43) Pub. Date: Dec. 18, 2003

(54) Lens array for use with array of fibers

(76) Inventors: Mark M. Meyers, Allentown, PA (US); C. David Carr, Orefield, PA (US); Michael Hahn, Allentown, PA (US); Dhiraj H. Malkani, Emmaus, PA (US)

Correspondence Address: CHRISTIE, PARKER & HALE, LLP, 350 WEST COLORADO BOULEVARD, SUITE 500, PASADENA, CA, 91105, US

(21) Appl. No.: 10/174,021

(22) Filed: Jun. 18, 2002

(51) Int. Cl. G02B 6/32

(52) U.S. Cl. 385/33

(57) ABSTRACT

An optical module is disclosed that includes a fiber array having two or more optical fibers formed in a linear array or a two dimensional array and a lens array having two or more lens elements monolithically formed on a first surface of a lens array substrate, wherein each of the two or more lens elements is optically coupled to a corresponding unique fiber in the fiber array. A second surface of the lens array substrate, opposite the first lens array substrate surface is coupled to the fiber array and the first and second lens array substrate surfaces are within less than about thirty arc seconds of parallel to reduce misalignment between the lens elements and their corresponding fibers.

### FIELD OF THE INVENTION

The present invention relates to a lens array, and more particularly, to a lens array for focusing an array of beams from an array of fibers.

### BACKGROUND OF THE INVENTION

Fiber optic technology is widely utilized in today's telecommunication and data communication networks. With the increased utilization of optical fibers, there is a need for efficient optical systems that assist in the transmission and the switching of optical signals. One important aspect of this technology is the interconnection of arrays of optical fibers to a variety of optical components, such as, for example optical switches or optoelectronic devices. For example, optical switches are currently being developed to direct light signals from an array of input optical fibers to any of several output optical fibers, without converting the optical signal to an electrical signal.

Various techniques may be utilized to interconnect an array of optical fibers with a switch or other optical components. Generally, however a high performance optical interconnect between an array of optical fibers and an array of optical devices preferably provides high coupling efficiency, ease of making the coupling, and low cost for manufacturing such an interconnect.

In practice an array of micro-lenses may often be used to couple an array of optical fibers to an array of active or passive optical components. Prior lens arrays have been constructed of silicon mounted inside of a metal housing. The metal housing is then actively aligned and assembled to a fiber module. The alignment and assembly often requires the use of spacers to ensure beam waist uniformity and collimation. In practice the accuracy of the alignment is sensitive to the parallel alignment of the lens array and the fiber array. Small tilts may cause a large refocus of different parts of the array resulting in large variations in the location of the beam waist across the array. Variation in the location of the beam waist diameter may result in the truncation of the optical beam and increased insertion loss. Conventional lens arrays may also be sensitive to decentration of the lens array relative to the fiber array, which may cause pointing errors for the entire array.

### SUMMARY OF THE INVENTION

In one aspect of the present invention an optical module includes a fiber array comprising a plurality of optical fibers and a lens array comprising a plurality of lens elements monolithically formed on a first surface of a lens array substrate, wherein each of said plurality of lens elements is optically coupled to a corresponding one of said fibers in said fiber array, and wherein a second surface of the lens array substrate is coupled to the fiber array and wherein the first and second lens array substrate surfaces are within less than about thirty arc seconds of parallel and wherein an index matching epoxy optically couples the second surface of said lens array substrate to a first fiber array surface.

In another aspect of the present invention an optical module includes an optically transparent lens array substrate, a plurality of lens elements formed on a first lens array substrate surface, a fiber array having a first fiber array surface coupled to a second lens array substrate surface, lens array alignment marks formed on the second lens array substrate surface and fiber array alignment marks formed on the first fiber array surface for visually aligning at least a portion of lens elements with corresponding fiber in the fiber array.

In a further aspect of the present invention a method for of coupling a lens array with a fiber array includes monolithically forming a plurality of lens elements on a first surface of a lens array substrate, coupling a second lens array substrate surface to an array of optical fibers wherein each of the plurality of lens elements is optically coupled to a one of the optical fibers within the fiber array and wherein the first and second lens array substrate surfaces are within less than about thirty arc seconds of parallel.

It is understood that other embodiments of the present invention will become readily apparent to those skilled in the art from the following detailed description. The described embodiments of the invention illustrate the best modes contemplated for carrying out the invention. As it will be realized, the invention is capable of other and different embodiments and the details are capable of modification in various other respects, all without departing from the spirit and scope of the present invention. Accordingly, the drawings and detailed description are to be illustrative in nature and not restrictive.

### BRIEF DESCRIPTION OF THE DRAWINGS

These and other features, aspects, and advantages of the present invention will become better understood with regard to the following description, appended claims, and accompanying drawings, in which:

FIG. 1 is a cross sectional view of a lens array coupled to a fiber array in accordance with an exemplary embodiment of the present invention;

FIG. 2 is a cross sectional view of the fiber array housing of the fiber array of FIG. 1 in accordance with an exemplary embodiment of the present invention;

FIG. 3 graphically illustrates the propagation of a Gaussian beam;

FIG. 4(a) is a graphical illustration of the reflectance of light reflected by the end face of an optical fiber having a fiber core with an index of refraction of 1.465 versus the index of refraction of an index matching epoxy in accordance with an exemplary embodiment of the present invention;

FIG. 4(b) is a graphical illustration of the back reflectance of the light reflected by the end face of an optical fiber having a fiber core with an index of refraction of 1.465 versus the index of refraction of an index mathcing epoxy in accordance with an exemplary embodiment of the present invention;

FIG. 5 is a flow chart illustrating a process for aligning the lens array and fiber array of FIG. 1 in accordance with an exemplary embodiment of the present invention;

FIG. 6 is a top view of a lens array having lens array alignment marks in accordance with an exemplary embodiment of the present invention; and

FIGS. 7(a) and 7(b) are top views of lens array alignment marks and fiber array alignment marks for visually aligning the lens array with the fiber array of FIG. 1 in accordance with an exemplary embodiment of the present invention.

### DETAILED DESCRIPTION OF THE INVENTION

An exemplary embodiment of the present invention provides a lens array for optically coupling an array of optical waveguides such as, for example, optical fibers, with an array of active or passive optical components. The light receiving and emitting ends of the optical fibers are often housed in fiber ferrules. The fiber ferrules may be coupled to an array of optical devices, such as, for example, an optical switch or optoelectronic transmitter via a lens array.

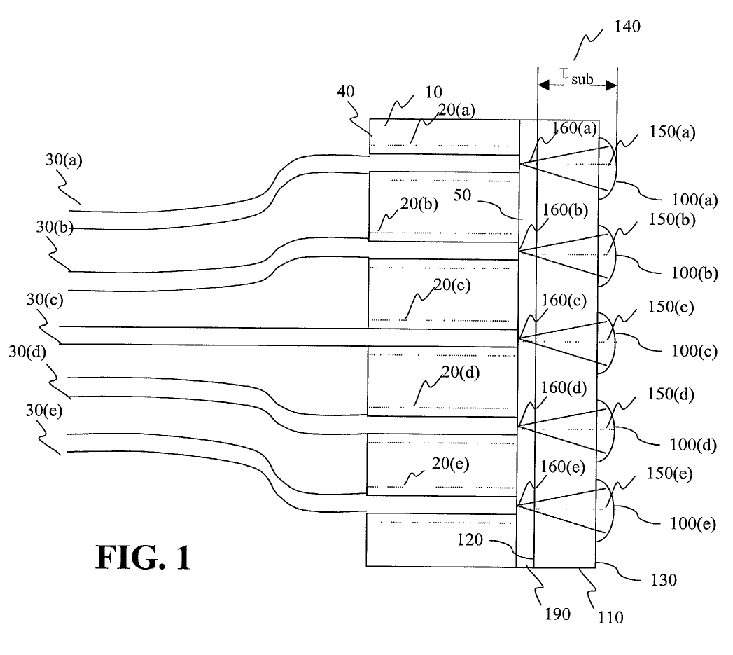

Several optical interface technologies and consortiums have evolved that provide standardized optical fiber array terminations. Generally, referring to FIG. 1, the fiber array may comprise a housing 10 having precision axial passageways 20(a-e) formed in the housing for receiving and retaining optical fibers 30(a-e) within its interior. The described exemplary axial passageways extend longitudinally from a back surface 40 of the fiber array toward a front surface 50 through the entire length of the housing. The array block may further include a well (not shown) in the upper surface of the block to dispense epoxy to secure the fibers in place without the need for springs or other retention mechanisms.

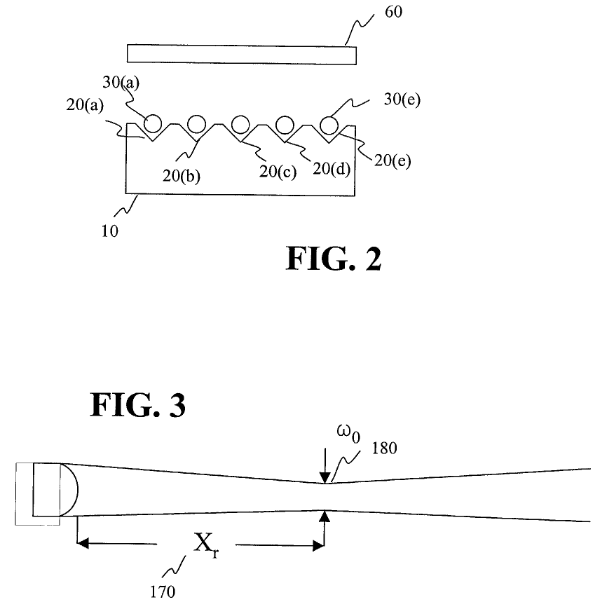

Alternatively, referring to FIG. 2, the axial passageways may comprise nested v-grooves 20(a-e) to retain the optical fibers. For ease of manufacturing the v-grooves may be formed in a single surface with the opposing surface 60 being flat to secure the fibers in the nested grooves.

One of skill in the art will appreciate that the present invention is not limited to the disclosed exemplary fiber array. Rather the present invention may be utilized to interface any array of optical fibers that terminates in a precise manner with an array of passive or active optoelectronic devices. For example, the fibers may be coupled into an array of adjacent ferrules or formed into an array by inserting the fibers into an etched silicon faceplate with lithographically defined fiber to fiber spacing. Therefore, the described exemplary fiber array is by way of example only and not by way of limitation.

Referring back to FIG. 1, in the described exemplary embodiment a one-dimensional (line array) or two-dimensional array of micro-lenses (100(a-e) for example) may be formed on an optically transparent lens array substrate 110. The micro-lenses may comprise for example aspheric, spheric, or other diffraction limited lenses as well as diffraction gratings or other diffractive optics. In an exemplary embodiment, the lens array substrate 110 may be formed, for example, from a silica, optical quality glass or a silicon substrate.

In the described exemplary embodiment, input and output substrate surfaces 120 and 130 respectively may be fabricated with a high degree of parallelism. Standard material processes such as, for example, high precision plastic or glass molding or double sided plano polishing may be utilized to fabricate the described exemplary lens array substrate 110 with highly parallel input and output surfaces. In accordance with an exemplary embodiment the input and output substrate surfaces may be within less than about thirty arc seconds of parallel.

In the described exemplary embodiment, the lens array may then be formed on the output substrate surface 130. The micro-lens array may be formed in accordance with any one of a variety of known etching processes such as, for example, photolithography and ion or chemical etching. In the described exemplary embodiment, the thickness 140 (τ_{sub}) of the substrate is approximately equal to the focal length 150(a-e) of the lens elements. Therefore, the back focus or vertex 160(a-e) of each of the lenses is located at or near the input surface 120 of the lens array substrate 110. Consequently, the vertex 160(a-e) of each lens element is substantially equidistant from its corresponding fiber 30(a-e) respectively, in the fiber array, providing uniform optical coupling between each of the fibers in the fiber array and its corresponding lens element.

One of skill in the art will appreciate that a plurality of techniques may be utilized to design the described exemplary lens array for a particular application. For example, standardized ray tracing programs may be used to design a lens array for a particular application. In practice a lens elements may often be designed to provide a particular spot size or beam diameter at a given wavelength at a given distance from the lens element. For a Gaussian beam, the irradiance of the beam is symmetric about the beam axis and varies with radial distance r from the axis as provided in Eq. 1.

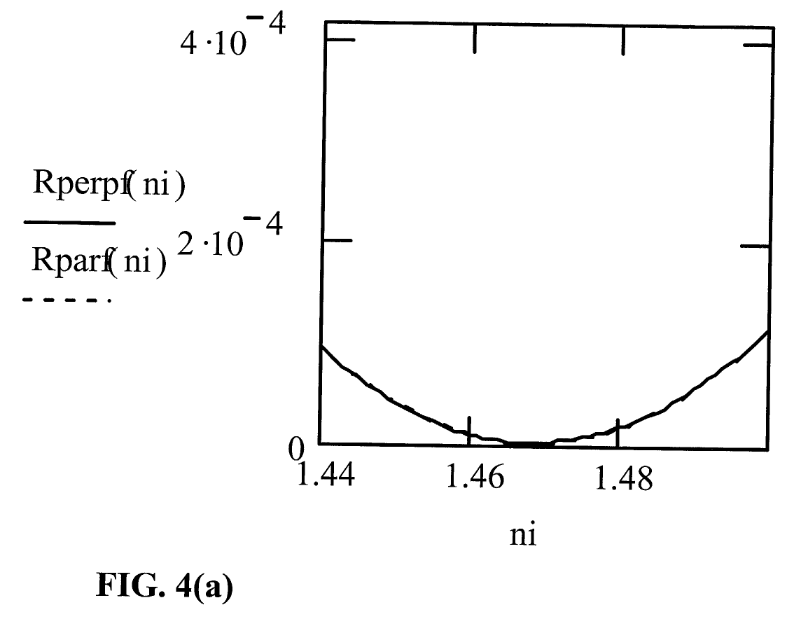

I(r)=I₀exp(−2r²/ω₀²) (1)

where ω₀, usually called the Gaussian beam radius, is the radius at which the intensity has decreased to 1/e² or 0.135 of its value on the axis. A Gaussian beam has a waist, where ω₀ is smallest. Referring to FIG. 3, the axial location of the beam waist and the beam diameter 180 may be characterized by the Rayleigh range 170 (Zᵣ) which is the distance from the beam waist where the beam diameter has increased by a factor of the square root of two times the beam waist (\sqrt{2}ω₀²) as provided in Eq. 2.

$$Zr = \frac{π {ω}_{0}^{2}}{4 λ} \qquad ( 2 )$$

In the described exemplary embodiment the focal point is located at or near the end face of the fiber. Therefore, the distance from the focal point of the lens element to the object, i.e. the end face of the fiber, is approximately equal to zero. For example, in an exemplary embodiment of the present invention the focal length of the lens is approximately equal to the distance from the fiber to the lens plus the Rayleigh range of the fiber, which is fiber approximately equal to 45 um for typical single mode fiber. Therefore, the focal length of the lens elements may be determined in accordance with Eq. 2, for a given target beam diameter, (i.e. set equal to the beam waist) and transmission wavelength λ. The radius of the lens r_{L} may then be estimated for a single surface lens in free space in accordance with the lens maker's equation as set forth in Eq. 3.

r_{L}=(n−1)/FL (3)

where n is the index of refraction of the lens and FL is the lens focal length. One of skill in the art will appreciate that a dual surface lens of a given thickness (t) may also be used. In this instance the relationship between the optical power φ, the lens focal length (FL) and the lens radii is set forth in Eqs. 4 and 5.

$$\begin{matrix}φ = ( n - 1 ) ( \frac{1}{{r}_{1}} - \frac{1}{{r}_{2}} ) ( \frac{t ( n - 1 )}{{nr}_{1} {r}_{2}} ) & ( 4 ) \\ FL = \frac{1}{φ} & ( 5 )\end{matrix}$$

where n is the index of refraction of the lens and r₁ is the radius of the first lens surface and r₂ is the radius of the second lens surface.

Therefore, in the described exemplary embodiment, the base radius of the lens array (r_{L}) may be selected so that the beam waist location and the degree of collimation are set by the thickness of the substrate. This eliminates the use of precision ground and mounted metal spacers to ensure uniformity of axial spacing of the array.

One of skill in the art will appreciate that diffraction loss or poor coupling efficiency may result from the truncation or clipping of the collimated optical beams. Therefore, clearances should be sufficiently large to reduce the diffraction losses to a predetermined level. For example, diffraction losses may limit the minimum physical size of apertures that the optical beam passes through or the minimum diameter of the optical device that the collimated beam is incident upon.

Therefore, in an exemplary embodiment of the present invention the distance between the focal point of the lens and the object distance (i.e. the distance between the lens element and the end face of the corresponding fiber in the fiber array) may be varied to change the location of the beam waist, the radius of the lens element, etc. depending on the application. In practice, small shifts in the placement of the fiber relative to the back focus position of the lens may be utilized to vary the size and location of the minimum beam diameter as well as the divergence of the beam beyond the beam waist. Generally, the diameter of the beam waist and the beam divergence after the waist are inversely related. Thus, the smaller the beam waist diameter, the larger the divergence of the beam after the beam waist

For example, in the described exemplary embodiment the distance between the fiber and the lens may be equal to the focal length of the lens plus the Rayleigh range of the fiber (approximately 45 um for typical single mode fiber) to modify the Gaussian beam waist location and diameter. In this embodiment the diameter of the collimated beam decreases for some distance beyond the focal length providing some tolerance on the clearance parameters to further mitigate the effects of truncation.

Conventional lens arrays typically include an antireflection coating on the rear surface of the lens array and on the end face of the fibers within the fiber array to reduce back reflection into the optical fiber. In addition, previous systems may also cleave or polish the end face of each of the fibers in the fiber array to a particular slant angle to further reduce the level of back reflection into the fiber. However, in an array having multiple rows of fibers, it may be difficult to uniformly align the angular pointing of each angled row of fibers relative to adjacent rows of fibers in the fiber array housing to ensure consistent optical coupling with each of the corresponding lens elements.

For example, light incident upon a cleaved or slanted fiber end face is refracted and transmitted at an angle relative to the mechanical axis of the fiber. Therefore, in operation the collimated beams exit the lens array at an angle relative to the surface normal of the lens array substrate complicating the alignment of the collimated optical beam with the optical devices. In practice, conventional systems having slanted fiber end faces may shape the fiber array faceplate to tilt the mechanical axis of the fiber relative to the surface normal of the lens array substrate to avoid this alignment difficulty. The shaped fiber faceplates are typically customized for each slant angle of the fiber end face, increasing the complexity and cost of the fiber array housing.

Referring back to FIG. 1, the described exemplary lens array substrate 110 however, may be readily coupled to the fiber array 10 with a UV curable, index matching epoxy 190. In the described exemplary embodiment the index of refraction of the lens array substrate may match the index of refraction of the fiber core. For example, in one embodiment the lens array substrate and fiber core may both be fabricated from fused silica. In accordance with an exemplary embodiment, the index matching epoxy may then match the index of refraction of the lens array substrate to within about ±0.01 of the index of refraction of the fiber core. The described exemplary embodiment therefore reduces the reflection of light back into the fiber (typically on the order of about −45 to −60 db back reflection suppression). The described exemplary embodiment may therefore eliminate the anti-reflective coatings that are often included in conventional systems as well as the need to cleave the end face of the fiber to further reduce back reflectance.

Alternatively, the fiber core and the lens array substrate may be formed from different materials whose indexes of refraction do not match. For normal incidence light the amplitude of the parallel and perpendicularly polarized light reflected from the end face of the fiber as a function of the index of refraction of the index matching epoxy (nᵢ) and the index of refraction of the fiber core (nₜ) is given in Eqs. 6(a) and 6(b) respectively.

$$\begin{matrix}rperpf ( {n}_{i} ) = \frac{{n}_{i} - {n}_{t}}{{n}_{i} + {n}_{t}} & 6 ( a ) \\ rparf ( {n}_{i} ) = \frac{{n}_{t} - {n}_{i}}{{n}_{i} + {n}_{t}} & 6 ( b )\end{matrix}$$

Eqs. 7(a) and 7(b) provide the corresponding intensity of the light reflected from the fiber end face.

Rperpf(nᵢ)=(rperf(nᵢ))² 7(a)

Rparf(nᵢ)=(rparf(nᵢ))² 7(b)

Similarly, Eqs. 8(a) and 8(b) provide the logarithmic decibel (db) values of the intensity of the light back reflected by the end face of the fiber.

BRperpf(nᵢ)=10 log(Rperf(nᵢ)) 8(a)

BRparf(nᵢ)=10 log(Rparf(nᵢ)) 8(b)

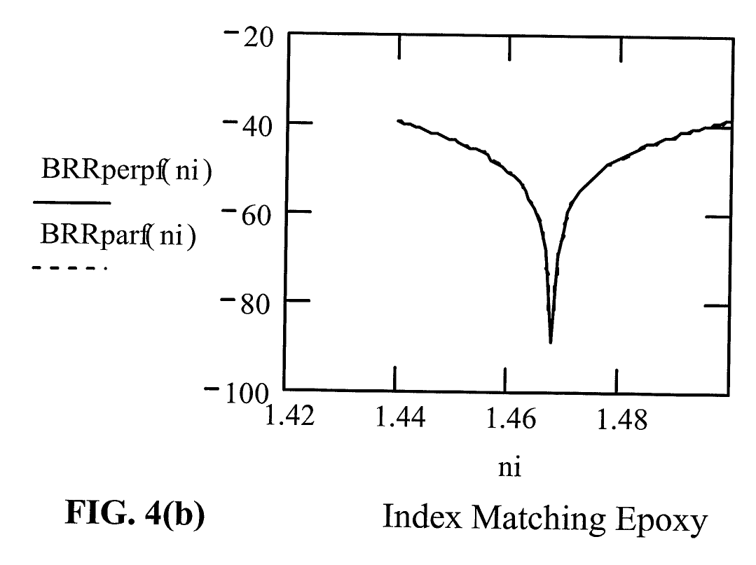

In this embodiment the index of refraction of the epoxy is preferably within about ±0.01 of the index of refraction of the fiber core to reduce back reflections into the fiber. For example, FIGS. 4(a) and 4(b) graphically illustrate the reflectance and return loss of the light reflected by the end face of the optical fiber as a function of the index of refraction of the index matching epoxy. It is assumed here that the fiber core is silica with an index of refraction of 1.465. Further, the reflectance or intensity of the light reflected by the end face of the fiber goes to zero as the difference in the index of refraction of the fiber core and index matching epoxy goes to zero.

In addition, an index difference of less than about ±0.01 between the index of refraction of the fiber core and the index of refraction of the index matching epoxy provides less than about −40 to −60 dB back reflectance into the optical fiber. Further, one of skill in the art will appreciate that in this embodiment, an intermediate anti-reflective coating may then be included on the rear surface of the lens array substrate to suppress reflections from the epoxy/lens array substrate interface.

In the described exemplary embodiment, the lens array substrate 110 may be optically transparent. In practice the optically transparent substrate may be utilized to reduce the complexity and cost often associated with the optical alignment of a lens array with a fiber array. In operation, efficient optical communication requires accurate optical alignment (i.e. efficient light coupling) between the lens elements and their corresponding optical fibers. Therefore, conventional systems often actively align the lens array with the fiber array by performing one or more alignment adjustments on each assembly. However, the complexity of the conventional active alignment process often leads to long assembly times and low yields.

For example, during active alignment the individual fibers emit light and the lens array is translated through a plurality of positions relative to the fiber array. Typical alignment systems individually measure the projected Gaussian beam diameter for a large number of lens/fiber pairs in the array for each of the relative positions of the lens array. The optimum relative position of the lens array may then be determined by taking a statistical average of the laser beam waist diameters and/or maximum intensity for each of the lens/fiber pairs at multiple axial and lateral positions of the lens array relative to the fiber array.

It will be appreciated that conventional active alignment procedures are therefore, labor intensive and may lead to long assembly times. In addition accurate active alignment typically requires expensive capital equipment to manipulate the lens array to the various positions with the required tolerances to allow mechanical attachment of the lens array to the fiber array. Active alignment may therefore add considerable cost to the manufacturing process and may limit high volume production of optical components. To avoid the aforementioned problems, an alignment approach in which a reduced number of active alignment adjustments is required is generally preferred.

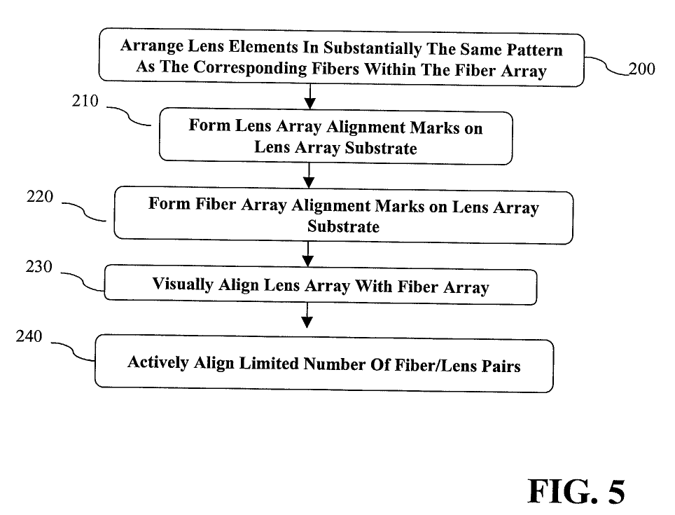

FIG. 5 illustrates an exemplary process for optically coupling a lens array monolithically formed on an optically transparent substrate with a fiber array. The described exemplary process allows for rapid and accurate alignment of at least a portion of the lens elements within the lens array with their corresponding fiber in the fiber array. In the described exemplary embodiment the lens elements are arranged on the lens substrate in substantially the same pattern as the corresponding fibers within the fiber array 200.

In the described embodiment lens array alignment marks may be accurately formed on at least one of the parallel surfaces (input and output surfaces 120 and 130 of FIG. 1) of the lens array substrate relative to the lens array 210. The lens array alignment marks may be formed in accordance with any of a variety of known techniques. For example, the alignment marks may be etched, deposited, machined, printed or formed by projecting an optical spot or cross hair onto the back of the lens array substrate.

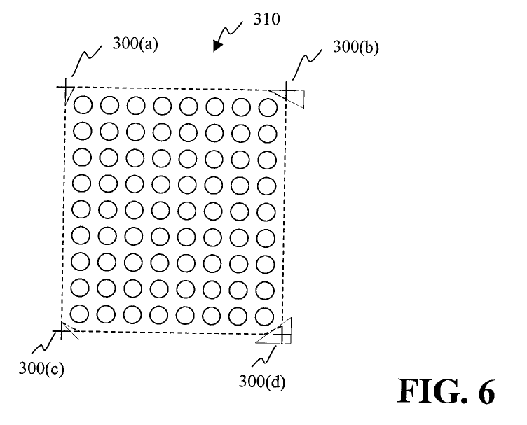

Referring to the top view of FIG. 6, alignment marks 300(a-d) may be formed, for example, at the corners of an exemplary rectangular two dimensional lens array 310. Referring back to FIG. 5, corresponding fiber array alignment marks may be formed on the fiber array surface 220 that is coupled to the lens array substrate. In one embodiment, the fiber alignment marks may be slightly larger than the corresponding lens alignment marks. In the described exemplary embodiment, the alignment marks may be a negative pattern of each other, a vernier type pattern, or other patterns that allow for precise visual alignment.

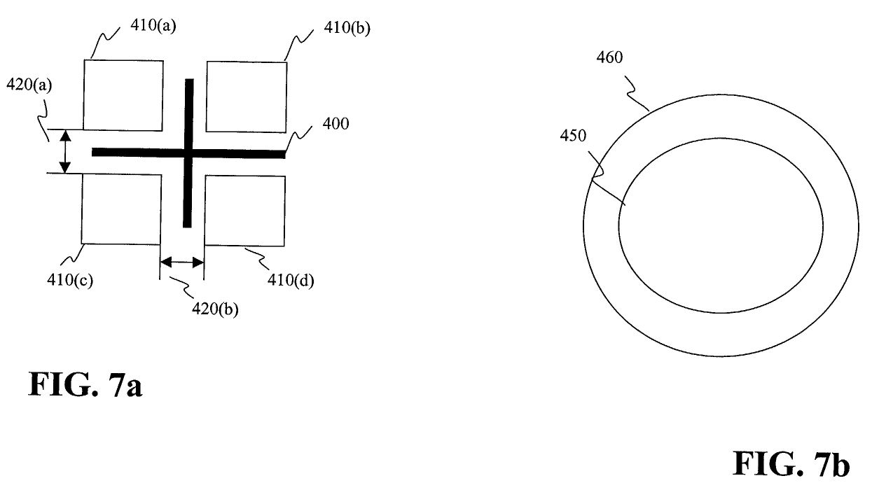

For example, referring to the top view of FIG. 7a the lens alignment mark may comprise a cross shaped mark 400 that may be visually aligned with a fiber alignment mark comprising two or more boxes 410(a-d) having spacings 420(a-b) that are slightly larger than the corresponding legs of the lens alignment mark 400 respectively. Alternatively, referring to FIG. 7b, the lens alignment mark may comprise a circle 450 having a first radius that may be visually aligned with a circular fiber alignment mark 460 having a second radius, larger than the first radius, by aligning the centers of the circles. One of skill in the art will appreciate that a variety of other alignment marks may be utilized to visually align the fiber array and lens array. Therefore, the described exemplary alignment marks are by way of example only and not by way of limitation.

In the described exemplary embodiment the lens array alignment marks are disposed at substantially the same positions with respect to the lens array as the fiber array alignment marks are positioned relative to the fiber array. In addition, in the described exemplary embodiment the lens array substrate is optically transparent and therefore permits the simultaneous viewing of the lens array alignment marks and the fiber array alignment marks.

Therefore, referring back to FIG. 5, the fiber array alignment marks and the lens array alignment marks may be utilized to perform an initial passive alignment of the lens array to the fiber array 230. In operation, when the alignment marks are coincident, the lens elements are appropriately centered over their corresponding fiber in the fiber array.

For example, in one embodiment a standard vision alignment system may utilize the alignment marks to precisely locate at least a portion of the lens elements of the lens array relative to their corresponding fiber in the fiber array. In operation, the lens array may be mounted on a set of well-controlled stages (not shown), allowing for translation and rotation as is known to those skilled in the art.

The described exemplary visual alignment system may then utilize image processing to perform pattern matching of the predetermined alignment marks formed on the lens array and the fiber array. The lens array and fiber array may then be fixed with relation to each other. This can be done in a number of ways known in the art, such as laser welding, sonic welding, heat staking, or epoxy. However, as previously described, in an exemplary embodiment of the present invention the lens array may be coupled to the fiber array with an index matching epoxy to reduce the back reflectance into the fiber.

In the described exemplary embodiment, the alignment tolerance of the lens elements relative to their corresponding fibers is on the order of about three-thirty microns. However, if necessary, active alignment measurements may be performed on a limited number of fiber/lens pairs to further improve the accuracy of the alignment 240. For example, in one embodiment the projected Gaussian beam diameter of a number of lens/fiber pairs at the extremities of the array may be individually measured.

For example, the projected Gaussian beam diameter of the corner elements of a square or rectangular array may be individually measured for a plurality of positions of the lens array relative to the fiber array. The optimum relative position of the lens array may then be determined by taking a statistical average of the laser beam waist diameters for this limited set of lens/fiber pairs at multiple axial and lateral positions of the lens array relative to the fiber array.

The utilization of an initial passive alignment procedure in conjunction with a limited number of active alignment steps may enhance the accuracy, speed and cost typically associated with the alignment of high precision optical components. Accurate alignment provides accurate beam pointing and high quality wave fronts from the lens array. Pointing control prevents truncation of the optical beam and the associated insertion loss. Similarly, wave front control prevents undesirable growth of the diameter of the optical beam, which may lead to truncation at the lens aperture and may also result in higher insertion loss.

Although exemplary embodiments of the present invention have been described, they should not be construed to limit the scope of the present invention. Those skilled in the art will understand that various modifications may be made to the described embodiments Further, the invention described herein will itself suggest to those skilled in the various arts, alternative embodiments and solutions to other tasks and adaptations for other applications. It is the applicants' intention to cover by claims all such uses of the invention and those changes and modifications that could be made to the embodiments of the invention herein chosen for the purpose of disclosure without departing from the spirit and scope of the invention.

What is claimed is:

1. An optical module, comprising:
a fiber array comprising a plurality of optical fibers; and
a lens array comprising a plurality of lens elements monolithically formed on a first surface of a lens array substrate, wherein each of said plurality of lens elements is optically coupled to a corresponding fiber in said fiber array and wherein a second surface of said lens array substrate is coupled to said fiber array and wherein said first and second lens array substrate surfaces are within about 30 arc seconds of parallel, and wherein an index matching epoxy optically couples the second surface of said lens array substrate to a first fiber array surface.

2. The optical module of claim 1 wherein each of said optical comprise a fiber core and fiber cladding and wherein index of refraction of said index matching epoxy is equal to index of refraction of said fiber core.

3. The optical module of claim 1 wherein index of refraction of said lens array substrate is equal to said first index of refraction.

4. The optical module of claim 1 wherein focal length of at least a portion of said lens elements is equal to thickness of said lens array substrate.

5. The optical module of claim 1 wherein distance between end face of each of said fibers and corresponding lens element equals focal length of the lens elements plus a predetermined spacer distance.

6. The optical module of claim 5 wherein said predetermined spacer distance equal Rayleigh range of the fiber.

7. The optical module of claim 1 wherein the lens array substrate is optically transparent.

8. The optical module of claim 7 further comprising lens array alignment marks formed on said second surface of said lens array substrate and fiber array alignment marks formed on said first fiber array surface for visually aligning at least a portion of said lens elements with corresponding fiber in said fiber array.

9. The optical module of claim 8 wherein said lens array alignment marks and said fiber array alignment marks comprise a negative pattern of each other.

10. The optical module of claim 8 wherein said lens array alignment marks and said fiber array alignment marks comprise a vernier pattern.

11. The optical module of claim 8 wherein said lens elements are located on the lens array substrate in substantially same pattern as corresponding fibers within the fiber array.

12. The optical module of claim 8 wherein the lens array alignment marks are disposed at substantially same positions with respect to the lens array as the fiber array alignment marks are disposed relative to the fiber array.

13. An optical module, comprising:
an optically transparent lens array substrate;
a plurality of lens elements formed on a first lens array substrate surface;
a fiber array having a first fiber array surface coupled to a second lens array substrate surface;
lens array alignment marks formed on said second lens array substrate surface; and
fiber array alignment marks formed on said first fiber array surface for visually aligning at least a portion of said plurality of lens elements with corresponding fiber in said fiber array.

14. The optical module of claim 13 wherein said lens array alignment marks and said fiber array alignment marks comprise a negative pattern of each other.

15. The optical module of claim 13 wherein said lens array alignment marks and said fiber array alignment marks comprise a vernier pattern.

16. The optical module of claim 13 wherein said lens elements are located on the lens array substrate in substantially same pattern as the corresponding fibers within the fiber array.

17. The optical module of claim 13 wherein the lens array alignment marks are disposed at substantially same positions with respect to the lens array as the fiber array alignment marks are disposed relative to the fiber array.

18. A method of coupling a lens array with a fiber array, comprising:
monolithically forming a plurality of lens elements on a first surface of a lens array substrate;
coupling a second lens array substrate surface to an array of optical fibers wherein each of said plurality of lens elements is optically coupled to a corresponding one of said optical fibers within said fiber array and wherein said first and second lens array substrate surfaces are within about 30 arc seconds of parallel.

19. The method of claim 18 further comprising forming lens array alignment marks on said second lens array substrate surface, forming fiber array alignment marks on a first fiber array surface and visually aligning at least a portion of said lens elements with corresponding fiber in said fiber array.

20. The method of claim 19 further comprising actively aligning a portion of lens element fiber pairs.
